(19) United States
(12) Patent Application Publication
(10) Pub. No.: US 2006/0270470 A1
(43) Pub. Date: Nov. 30, 2006

(54) Wireless communication inside shielded envelope

(76) Inventors: Michael de La Chapelle, Bellevue, WA (US); Dave W. Bogart, Renton, WA (US)

Correspondence Address: HARNESS, DICKEY & PIERCE, P.L.C., P.O. BOX 828, BLOOMFIELD HILLS, MI, 48303, US

(21) Appl. No.: 11/440,300

(22) Filed: May 24, 2006

Related U.S. Application Data
(60) Provisional application No. 60/684,199, filed on May 24, 2005.

(51) Int. Cl. H04M 1/00

(52) U.S. Cl. 455/575.5

(57) ABSTRACT

A system and method for preventing use of cellular/PDA devices on-board a mobile platform, such as an aircraft. The system involves using the shielding of the fuselage of the aircraft to provide a first degree of signal-to-noise ratio attenuation of signals from terrestrial wireless access points entering into the interior cabin area of the aircraft. A noise floor lifter subsystem raises the noise floor level within the aircraft to provide a second degree of attenuation of the signal-to-noise ratio of the signal entering the aircraft. By using the shielding of the fuselage, communication of the cellular/PDA devices can be prevented with a lesser degree of noise floor lifting within the aircraft, thus reducing the chance of interference with terrestrial wireless access points and/or interference with important navigation or avionics subsystems within the aircraft.

### CROSS-REFERENCE TO RELATED APPLICATIONS

This application claims the benefit of U.S. Provisional Application No. 60/684,199, filed on May 24, 2005. The disclosure of the above application is incorporated herein by reference.

### FIELD

The present disclosure relates to systems and method for controlling communication of cellular devices within shielded mobile platforms, such as within commercial aircraft, and more particularly to a system and method for preventing the use of cellular devices within a mobile platform by making use of the shielding of the mobile platform body portion in combination with generating a noise signal within the body portion of the mobile platform.

### BACKGROUND

The use of personal wireless devices such as cellular phones, notebook computers and personal digital assistants for operation on mobile platforms, hereinafter generally referred to as aircraft, creates several problems. One problem is that cellular (cell) phone handsets on-board aircraft at cruise elevation (e.g., approximately 10,668 m (35,000 ft.)) have line-of-sight visibility for approximately 426 km (265 miles) in all directions. This area can encompass tens, hundreds, or even thousands of cell phone base stations, causing interference and reducing the system capacity over a vast area. A single cell phone call at 10,668 m can use spectral resources equivalent to tens, hundreds, or thousands of terrestrial cell phone calls.

Another problem with cell phone usage aboard aircraft in flight is potential interference with on-board flight critical navigation and communication systems. Radio frequency (RF) radiation emitted from cell phones or other wireless devices can escape the fuselage of the aircraft through the window openings and propagate along the skin of the aircraft where the signals can impinge on the external antennas used for flight critical functions. The problem can be exacerbated by common wireless communication protocols that command the cell phone handset to increase its transmit power level to establish and maintain communication with terrestrial base stations. The long path distance and the signal attenuation introduced by the metallic fuselage usually cause the cell phone to operate at elevated power levels when communicating with terrestrial located base stations, increasing the potential to interfere with on-board electronic equipment and increasing the potential RF exposure to passengers.

Picocell antennas have been deployed in confined spaces such as buildings and rooms to allow occupants to communicate using cellular phones and wireless computing devices. This type of equipment has also had very limited deployment inside aircraft cabins. One major technical problem is that there is no guarantee that passengers using mobile phones on aircraft will connect to a picocell within the aircraft. If a higher signal strength is measured by a given passenger's hand set receiver to an external cell tower (base station) rather than the internal picocell, his/her cell phone can connect to the external tower. This scenario can often occur when a passenger is seated near a window of the aircraft and the base station is relatively close to the aircraft. It is also impractical to establish on-board picocells for every global variant of cell phone standards and frequency (i.e., GSM, GPRS, EDGE, iDEN, CDMA, JCDMA, TDMA, AMPS, 3G, etc.). A commercial aircraft will therefore generally offer only one or two, or a small subset of all of the cell phone standards used by passenger phones. It is therefore difficult to allow only the wireless services that are supported by on-board picocells while excluding all others. It is unreasonable to expect the flight crews of commercial airlines to police the cell phone usage of their passengers in order to assure all non-supported cellular technologies are sufficiently attenuated from interfering with terrestrial networks.

The above problems are overcome by the system and method disclosed in U.S. application Ser. No. 10/435,785, filed May 12, 2003, entitled “Wireless Communication Inside Shielded Envelope”, assigned to The Boeing Company. The U.S. Ser. No. 10/435,785 application involves making use of the shielding provided by the fuselage of a mobile platform, and further constructing the windows of the mobile platform in a manner which also provides shielding of electromagnetic wave radiation. Thus, electromagnetic wave radiation from terrestrial wireless access points is not able to penetrate the fuselage or windows of the mobile platform with sufficient power remaining inside the cabin area of the mobile platform to enable cellular devices of users to connect with the terrestrial wireless access point.

While the foregoing system disclosed in U.S. application Ser. No. 10/435,785 achieves the objective of sufficiently attenuating wireless signals being radiated from outside of the mobile platform to prevent the use of cellular devices from inside the mobile platform, it would still be desirable, in some implementations, to be able to prevent the use of cellular devices inside the mobile platform with a lesser degree of electromagnetic shielding (i.e., without relying entirely on the shielding of the fuselage itself). It will be appreciated that in some cost sensitive applications, it would be desirable to rely on the shielding of the mobile platform itself to provide only a portion of the needed signal strength attenuation for electromagnetic wave signals entering the interior cabin area of a mobile platform from a remotely located terrestrial wireless access point. However, if the shielding is insufficient to provide the needed degree of signal attenuation within the interior cabin area of the mobile platform, then some other means of augmenting the signal attenuation would be required to achieve the needed degree of attenuation to prevent cellular devices from connecting with remotely located wireless access points, and thereby potentially causing interference with on-board electronics or navigation systems of the mobile platform.

### SUMMARY

The system and method of the present disclosure relates to using the shielded body portion of the mobile platform, in one form a fuselage of a commercial aircraft, to provide a first degree of signal-to-noise attenuation of wireless signals being radiated from a terrestrial, remote wireless access point into the interior cabin area of the mobile platform, and providing a second degree of signal-to-noise attenuation through the use of a noise generator located within the interior area of the mobile platform. In one preferred method, the shielding of the mobile platform provides about 50% of the needed signal-to-noise attenuation of the electromagnetic wave signal radiating into the interior area of the mobile platform to prevent use of cellular devices within the mobile platform. The noise generator is used to provide the remainder of the needed signal strength attenuation.

In one implementation a white noise generator is provided within the mobile platform to raise the noise “floor” within the mobile platform. The white noise generator generates a white noise signal having a generally constant power spectral density, and over a frequency bandwidth in which cellular devices are required to operate.

The various embodiments and implementations enable cellular communications to be prevented by users on the mobile platform at those times where such communication might interfere with various electronic or navigation subsystems on a mobile platform. Advantageously, a lesser degree of shielding from the structure of the mobile platform itself is required to achieve this, because of the increase in the noise floor provided by the noise generator within the mobile platform.

Further areas of applicability of the present disclosure will become apparent from the detailed description provided hereinafter. It should be understood that the detailed description and specific examples are intended for purposes of illustration only and are not intended to limit the scope of the present disclosure.

### BRIEF DESCRIPTION OF THE DRAWINGS

The present disclosure will become more fully understood from the detailed description and the accompanying drawings, wherein:

FIG. 1 is a side elevational view of an aircraft having the wireless communication system of the present disclosure;

FIG. 2 is an elevational view similar to FIG. 1 identifying a wireless device use according to an embodiment of the present disclosure;

FIG. 3 is a partial cross sectional view taken at Section line 3 of FIG. 2 showing an exemplary aircraft window assembly incorporating an embodiment of a conductive coating of the present system;

FIG. 4 is an elevational view of an exemplary window of a mobile platform showing the transparent conductive film and bus bar of the present system disposed thereon;

FIG. 5 is an elevational side view of the window of FIG. 4, identifying an exemplary procedure for installing a layer of transparent conductive film of the present system;

FIG. 6 is a partial cross sectional view similar to FIG. 3, showing the addition of grounding straps in another embodiment of the present system;

FIG. 7 is a block diagram showing the steps to control wireless device transmission according to an implementation of the present system;

FIG. 8 is a simplified block diagram drawing of an embodiment of an alternative implementation of the present system in which a noise floor lifter system is employed within the aircraft to assist in attenuating the signal-to-noise ratio of electromagnetic wave signals entering into the interior of the aircraft from a remote, terrestrial wireless access point;

FIGS. 9A-9D are waveforms illustrating how the present system and method makes use of shielding attenuation as well as noise floor lifting to achieve the needed degree of reduction in the signal-to-noise ratio of electromagnetic wave radiation entering the interior of the mobile platform; and

FIG. 10 is a plot of power spectral density versus frequency within the fuselage of the mobile platform, as well as outside the fuselage, illustrating how the shielding of the fuselage assists in attenuating transmissions from cellular devices from within the mobile platform to a level that is substantially equal to the ambient thermal noise level outside the mobile platform.

### DETAILED DESCRIPTION

The following description of the various embodiments is merely exemplary in nature and is in no way intended to limit the present disclosure, its application, or uses.

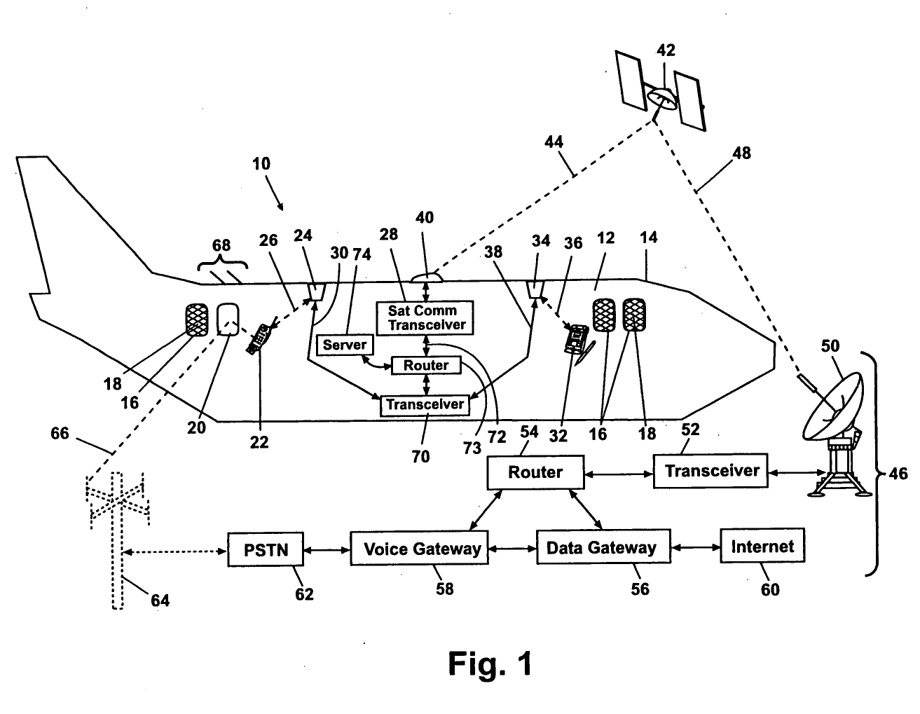

Referring to FIG. 1, a wireless communication system 10 according to an embodiment of the present disclosure is shown. An exemplary aircraft 12 includes a fuselage 14 and a plurality of windows 16 disposed in the fuselage 14. Each of the windows 16 includes a conductive film 18 disposed over at least one surface thereof. An unshielded window 20, lacking a conductive film 18, is shown for discussion in further detail below.

One or more wireless cellular devices 22 are wirelessly linked to one or more picocell antennas 24 via a radio frequency (RF) signal path 26. In the preferred embodiment, the picocell antenna(s) 24 are each connected to one of a plurality of picocell/gateway transceivers 70 via an RF line 30. Similarly, one or more passenger wireless network devices 32 are connected to one or more wireless network gateway antennas 34 via a wireless data line 36. The wireless network gateway antennas 34 are each connected to the picocell/gateway transceivers 70 via an RF line 38. A satellite communication transceiver (Sat Comm Transceiver) 28 is in communication with an antenna 40, mounted on the outside of the fuselage 14, for wirelessly conveying RF signals to/from each of the wireless cellular devices 22 and the wireless network devices 32, and a satellite 42, via an antenna-to-satellite path 44.

The satellite 42 is in wireless communication with a ground station 46 via a satellite-to-ground signal path 48. The ground station 46 includes a ground-based antenna 50 in communication with a transceiver 52, which relays signals to/from the ground-based antenna 50 and a signal router 54. The signal router 54 splits signals between data signals and voice communication signals, forwarding data signals to a data gateway 56, and forwarding voice communication signals to a voice gateway 58. At the data gateway 56, data signals are further transmitted or received to/from the Internet 60. At the voice gateway 58, voice communication signals are further transmitted or received to/from a public switched telephone network (PSTN) 62. Two-way traffic from the wireless cellular device(s) 22 and the wireless network device(s) 32 to the ground station 46 is thereby provided. The path from the antenna 40 to the ground station 46, which includes the antenna-to-satellite path 44, the satellite 42, the satellite-to-ground signal path 48, and the ground-based antenna 50 is a preferred path for wireless signal communication between the aircraft 12 and the ground station 46. Installation of the conductive film 18 sufficiently attenuates the signal strength between cellular device 22 within aircraft 12 and an exemplary terrestrial cellular phone tower/base station 64, along a wireless communication path 66, to disable all communication along the communication path 66.

According to a particular embodiment of the present invention, at least one picocell antenna 24 is disposed within the fuselage 14 of the aircraft 12. Electromagnetic radiation from the wireless cellular device 22, which is blocked by the conductive film 18 disposed over each of the windows 16 and 20, is wirelessly transmitted to the picocell antenna 24 via radio frequency (RF) signal path 26. Picocell antenna 24 is a remote antenna with an RF transmission line interface to the one or more transceivers 70 wherein the RF signal is processed into a digital signal. Each picocell antenna 24 communicates with transceiver 70 via RF line 30 for subsequent transmission via a router 73, satellite communication transceiver 28 and antenna 40 to the satellite 42. Router 73 only accepts in-coming packets addressed to aircraft 12 and multiplexes outgoing packets into a single data stream. A server 74 controls the wireless access to picocell antennas 24 and wireless network gateway antennas 34. Data transmission signals from the wireless network devices 32 are received by one of the wireless network gateway antennas 34 (also commonly referred to as access points) disposed within the fuselage 14 of the aircraft 12. Similar to the picocell antennas 24, a plurality of wireless network gateway antennas 34 can be used. The picocell antennas 24 and network gateway antennas 34 act as “transceiver hubs”, collecting wireless signals.

In an alternate embodiment, (not shown), picocell antenna 24 incorporates an RF transceiver, modem and a signal processor, and the interface to transceiver 70 is digital. In this alternate embodiment, the picocell antenna 24 can be directly connected to router 73. In another alternate embodiment, the picocell/gateway transceivers 70 and the picocell antenna(s) 24 are combined into a single unit (not shown) which is in communication with router 73 via one or more data lines (not shown). Additionally, the picocell/gateway transceivers 70 and the wireless network gateway antennas 34 are also combined into a single unit (not shown) which is in communication with router 73 via one or more data lines (not shown).

By incorporating both the picocell antennas 24 and the wireless network gateway antennas 34, and disposing the conductive film 18 over each of the windows 16 and 20, wireless devices operated within the aircraft 12 can only achieve connectivity outside of the aircraft 12 by accessing either picocell antennas 24 for telephony, or wireless network gateway antennas 34, using radio frequency signal path 26 and wireless data line 36, respectively. Any wireless device inside (inboard) the aircraft 12 that is not able to access picocell antennas 24 or wireless network gateway antennas 34 will not be able to achieve connectivity outside (outboard) the aircraft 12 because of the RF shielding provided by conductive film 18. The communication path 66 is blocked to all wireless cellular devices 22 and all wireless network devices 32 by the RF shielding provided by conductive film 18. The wireless communication system 10 of the present invention also reduces the amplitude of electromagnetic radiation escaping from fuselage 14 due to emissions from wireless cellular devices 22 or wireless network devices 32 that penetrate windows 16 and follow a propagation path along the skin of the conductive fuselage 14 to impinge on a plurality of safety critical navigation and communication system antennas 68 (used for navigation and communication) that are mounted on the outside surface of fuselage 14. This radiation can potentially interfere with flight operations of aircraft 12.

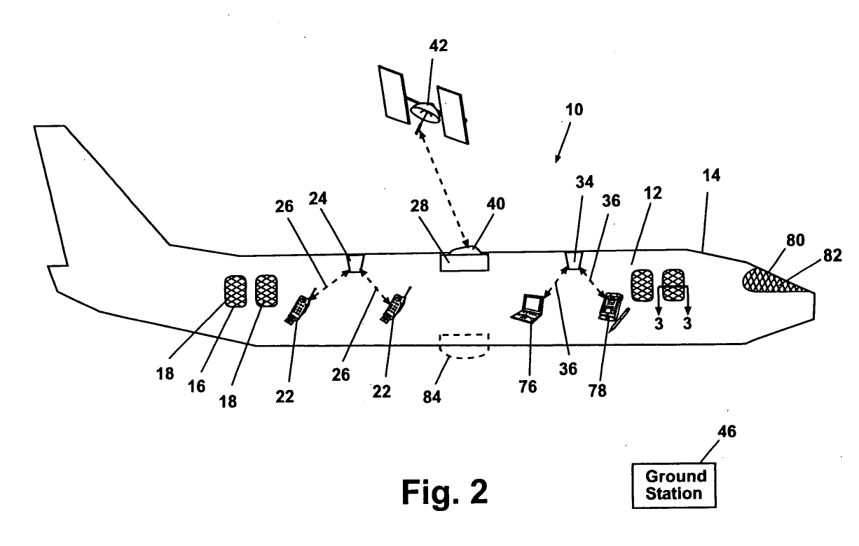

As best seen in FIG. 2, each of the picocell antennas 24 and the wireless network gateway antennas 34 are sized to accommodate one or more wireless devices. The number of the picocell antennas 24 and the wireless network gateway antennas 34 to be installed will depend on several factors including: the size of the aircraft 12, the geometry of the fuselage 14, the anticipated number of wireless devices to be operated during use of the aircraft 12, and other factors including expected power output of each wireless device, operating frequency for each wireless device, and proximity of the wireless devices to each of the picocell antennas 24 and the wireless network gateway antennas 34. An exemplary pair of the wireless cellular devices 22 are shown. Exemplary wireless network devices 32 shown include a wireless laptop computer 76 and a personal electronic device, such as a personal digital assistant 78.

FIG. 2 also shows at least one cockpit window 80 disposed in the aircraft 12. Each cockpit window 80 is commonly provided with a conductive film 82 which permits deicing and defogging of the cockpit window 80. On aircraft that are not equipped with the deicing capability of the conductive film 82, a conductive film 18 and a grounding method of the present disclosure can be used on each of the cockpit windows 80.

FIG. 2 shows a preferred embodiment having communication paths utilizing the antenna 40, the satellite 42, and the ground station 46. The satellite 42 and the ground station 46 are exemplary of devices disposed in the communication path between the aircraft 12 and any ground based communication terminal. A further embodiment of the present disclosure uses direct communication between an external antenna 84 and the ground station 46. For this approach (shown in phantom), the external antenna 84 is preferably mounted at the base of the fuselage 14 where it has an unobstructed communication path to ground station 46.

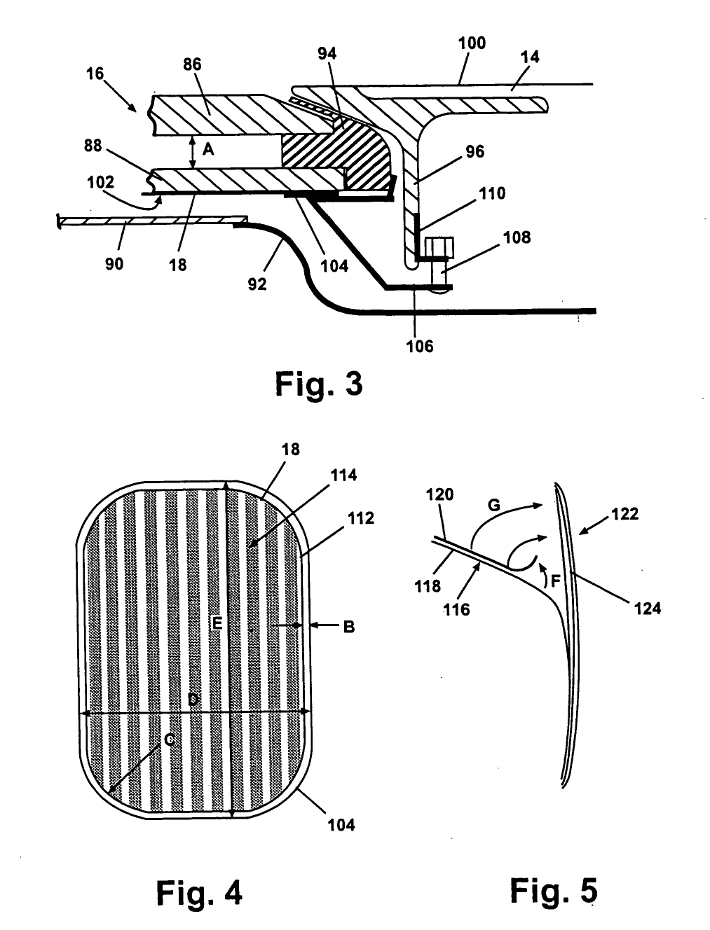

As best seen in FIG. 3, a common commercial aircraft configuration for the window 16 is shown in cross section, where the window 16, (shown as an assembly), meets the window opening in fuselage 14 of aircraft 12. The window 16 includes an external pane 86, an internal pane 88, and a protective pane 90 that is part of a cabin wall 92. The protective pane 90 is typically provided on the passenger side of the fuselage of the aircraft. A seal 94 is an integral part of window assembly 16 and is used to join the internal pane 88 and external pane 86 and to prevent pressurized cabin atmosphere from escaping through the interface between window 16 and a window forging 96, which is attached to fuselage 14. Window panes 86 and 88 are typically formed of plastic, however, window pane material can also be glass or composites of a variety of materials. As the aircraft increases in operating altitude, internal pressure of the aircraft exceeds external pressure, and the window 16 typically displaces outward, which compresses seal 94 to prevent internal atmosphere from escaping.

Present day commercial aircraft include the cabin wall 92, typically made of a plastic material, disposed along the passenger facing interior envelope of the aircraft. The protective pane 90 is connectably disposed to the cabin wall 92. An exterior skin 100 of fuselage 14 is structurally reinforced at the window openings by the plurality of window forgings 96 that are inserted into the window openings. The exterior skin 100 and the window forgings 96 are typically formed of metal materials that are electrically conductive. An alternate carbon fiber exterior skin 100 of aircraft 12, employing composite materials, is also electrically conductive and provides significant RF shielding capability. With the exception of the windows 16, the entire fuselage 14 of most commercial aircraft is therefore electrically conductive and forms a barrier to wireless electromagnetic radiation penetrating the exterior skin 100 of an aircraft. According to the present disclosure, the conductive film 18 is disposed along at least one of the external pane 86 and/or the internal pane 88 of each window 16. In a specific embodiment shown in FIG. 3, the conductive film 18 is disposed on an interior facing side 102 of the internal pane 88 of window 16. An electrically conductive bus bar 104 is disposed about a perimeter of the internal pane 88 and in electrical contact with the conductive film 18. A clip 106 is biased into contact with the bus bar 104 and fixed to the window forging 96 via a fastener 108 and a bracket 110. The clip 106, the fastener 108, and the bracket 110 are selected from electrically conductive materials, such as metals, such that electromagnetic radiation which contacts the conductive film 18 is grounded via the bus bar 104, the clip 106, the fastener 108 and the bracket 110 to the window forging 96 and the skin 100 of fuselage 14.

The conductive film 18 grounds the surface area of each of the windows 16 to the exterior skin 100 of the aircraft. This forms a Faraday cage within the fuselage of the aircraft in which electromagnetic energy can neither enter or escape from the fuselage 14. Electromagnetic radiation from wireless communication devices within the aircraft is blocked at each of the windows 16 by the conductive film 18. In one specific embodiment of the present disclosure, individual clips 106 are used and intermittently spaced about the perimeter of each of the windows 16 making contact with bus bar 104. On present day commercial aircraft, approximately 10 clips 106 are employed to mount each of the windows 16 to the window forging 96. The clips 106 put pressure on the window 16 to hold it against window forging 96 which provides good electrical contact to bus bar 104. The clips 106 maintain contact with the bus bar 104 as the window 16 is pressed into the window forging 96 by increasing differential cabin pressure. Thus, spring loading of the clips 106 assures good electrical contact with bus bar 104 as the aircraft 12 varies altitude.

Referring next to FIG. 4, an exemplary internal pane 88 of window 16 is shown having the conductive film 18 disposed on a surface thereof. The conductive film 18 includes a plastic, semi-transparent film 112 having a thin conductive coating 114 formed thereon. The conductive coating 114 is typically formed of metal or metal oxide. Gold or silver are commonly used. An exemplary semi-transparent film 112 is manufactured by CP Films, Incorporated, of Martinsville, Va. The CP Films, Incorporated conductive film is disposed on a plastic polymer substrate. A gold film is disposed thereon and a heat stabilized clear hard coated film coated thereover. The CP Films, Incorporated conductive film has a visible light transmittance of approximately 75% or greater, with a surface resistance ranging from approximately 4.5 to 10 ohms per square inch.

In a specific embodiment, the bus bar 104 is formed together with the conductive film 18 and applied as an appliqué. The conductive film 18 and the bus bar 104 can also be formed by silk screening, sputtering or evaporation. The bus bar 104 is typically formed of metal that is thicker than that used for the transparent conductive portion of the conductive film 18. Hence, the bus bar 104 is opaque and has much lower electrical resistance than the semitransparent conductive film. The bus bar 104 does not block or compromise the optical qualities of the window 16 because it is placed around its periphery. The bus bar 104 is applied to the same surface of the polymer conductive film 18 on which the semitransparent conductive coating is applied. This enables excellent electrical contact between the semitransparent conductive surface and the bus bar 104. Adhesive (not shown) is applied to the surface of the conductive film 18 that is opposite to the side having the bus bar 104.

The exemplary internal pane 88 is shown having a bus bar width “B” of 0.6 cm (0.25 in), a window corner radius “C” of 9.9 cm (3.9 in), a window width “D” of 28.7 cm (11.3 in), and a window height “E” of 38.9 cm (15.3 in). It should be obvious that these dimensions are exemplary of a variety of window dimensions available for aircraft or any mobile platform use.

As best seen in FIG. 5, a specific embodiment of the present disclosure uses a window appliqué 116 that is formed of a conductively coated polymer sheet 118 with integral bus bar (not shown) and adhesive backing. A protective backing 120 is used to cover the adhesive surface of the window appliqué 116. The window appliqué 116 is applied to a window 122 by peeling off the protective backing 120 in the direction of arrow “F” and pressing the adhesive surface against the window, in the direction of arrow “G”, being careful to avoid air pockets or bubbles. Installation of window appliqué 116 on an internal pane 124 of window 122 is demonstrated. The polymer sheet 118 has an adhesive backing (not shown) which adheres to the internal pane 124 as the polymer sheet 118 is pressed in the installation direction “G” onto the internal pane 124.

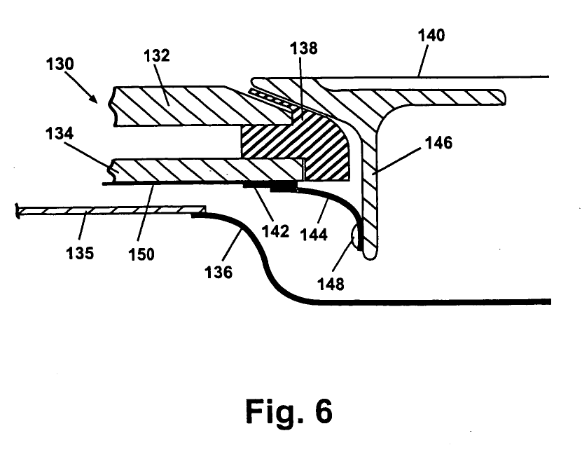

As best shown in FIG. 6, an alternate embodiment of the present disclosure provides a window assembly 130 having an external pane 132, an internal pane 134 and a protective pane 135 that is part of a wall panel 136. A seal 138 is disposed between the external pane 132, the internal pane 134, and an exterior skin 140 of a mobile platform. At least one bus bar 142 is disposed about the perimeter of the internal pane 134. In the embodiment shown in FIG. 6, a clip may or may not be used to hold the window assembly 130 in place. In this embodiment, the clips do not provide a grounding path to the fuselage. Instead, one or more grounding straps 144 are disposed between each bus bar 142 and the exterior skin 140 or window forging 146. Each grounding strap 144 is connected using a fastener 148. A semi-transparent conductive film coating 150 is disposed on the internal pane 134 and electrically connected to the bus bar 142.

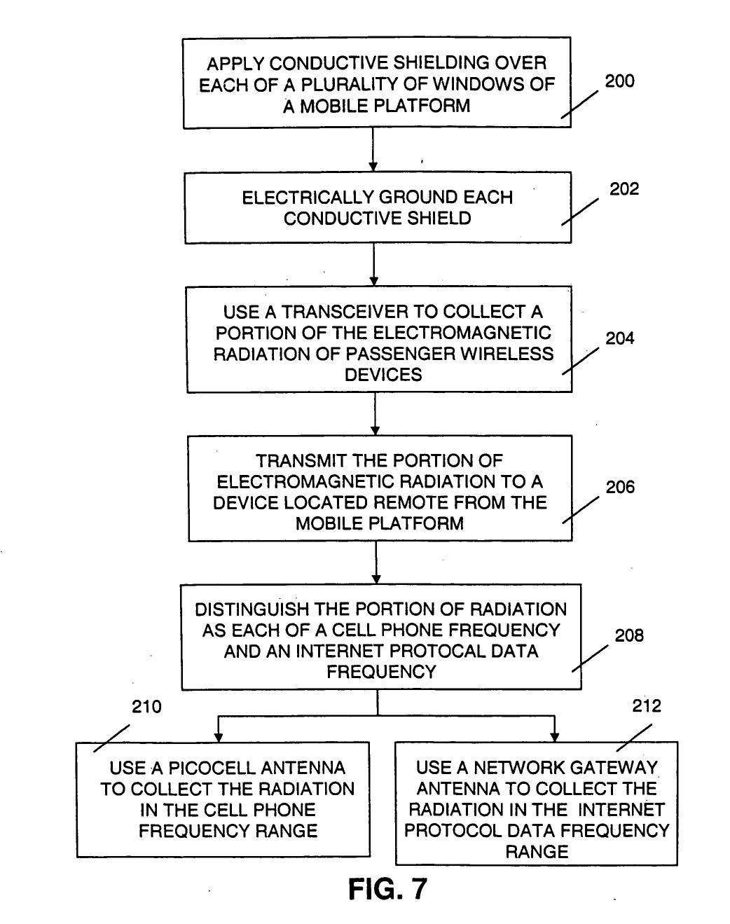

Referring to FIG. 7, an exemplary implementation of the operations to control wireless device transmission within a mobile platform is presented. In an operation 200, a conductive shielding is applied over each of a plurality of windows of a mobile platform. At operation 202, each conductive shield is electrically grounded to the mobile platform. Following in operation 204, a transceiver is used to collect a portion of the electromagnetic radiation from passenger wireless devices on-board the mobile platform. In operaiton 206, the portion of electromagnetic radiation is transmitted to a device located remote from the mobile platform. In an operation step 208, the portion of radiation is distinguished as each of a cell phone frequency range and an Internet protocol data wireless access point frequency range. In a first parallel operation 210, a picocell antenna is used to collect radiation generated in the cell phone frequency range. In a second parallel operaiton 212, a network gateway antenna is used to collect radiation generated in the Internet protocol data wireless access point frequency range.

The wireless communication system of the present disclosure offers several advantages. Direct communication between the wireless communication devices and base stations external to the mobile platform can be prevented by blocking RF signals from entering or existing the aircraft fuselage using conductive films disposed over each of the windows of the mobile platform. This prevents the wireless communication devices used on the aircraft from directly accessing a plurality of terrestrial cellular base stations and network gateways, for instance while an aircraft is at flight elevation. The wireless communication system of the present disclosure provides internal picocells and/or wireless network gateways for wireless communication with passenger operated wireless devices. The close proximity of the picocells and network gateways to the wireless passenger devices within the aircraft cabin enables these devices to communicate at very low power levels, further reducing the potential for interference with flight critical aircraft electronics. Many wireless devices such as cellular phones automatically adjust their transmit power to the minimum necessary to establish and maintain communication with the picocell. Placing the picocell inside the aircraft cabin in close proximity to the passenger cellular phones leads to a large reduction of transmit power levels (typically orders of magnitude) compared to the power levels that the cell phone would require to establish direct communications with a terrestrial cellular base station from within a typical aircraft that is not equipped with the RF window shielding of this invention. Thus, the on-board picocell of the present disclosure effectively reduces the aggregate RF power density within the fuselage of the aircraft. This reduces the perceived negative health effects of RF radiation within the aircraft cabin and reduces interference with flight critical aircraft electronics.

Typical cellular phones can emit 500 mW or more of power when they must communicate over the long distances that are typical between an aircraft at cruise altitude and a terrestrial base station and when they incur signal losses during propagation through the fuselage and unshielded window openings. In contrast, the present disclosure permits both the passenger wireless devices and the picocells/gateways to operate at very low power, i.e., 10 mW or less. By blocking the radiation pathway through the windows of a mobile platform using the conductive film of the present disclosure, electromagnetic radiation from wireless devices within the mobile platform cannot escape through the window and cause interference with the externally mounted antennas of the mobile platform. This forces passenger wireless devices to connect to the on-board picocells/gateways, or, if the on-board picocells/gateways do not support their communication standard, the devices will be disabled from operating by the high attenuation of the shielded aircraft windows of the invention. Most cellular phones will enter a hybernation mode when they are not able to communicate with a cellular base station (either on-board the aircraft or off-board the aircraft).

By using picocell antennas, a service range of approximately one hundred meters or less is provided which is adequate for operation within the enclosed spaces of a typical mobile platform. Use of multiple picocell antennas and/or wireless network gateways also provides operational access by a wireless device located anywhere within the mobile platform to access the antenna of the mobile platform. The wireless communication system 10 of the present invention is operable within a frequency range between approximately 100 kHz up to approximately 100 gHz.

Common wireless telephone systems in use today are designed for a maximum of approximately 30 decibel (dB) environmental losses between the base station 64 and the wireless cellular device 22 due to multi-path fading, object penetration (buildings, etc.), etc. Cellular systems are designed to operate with a maximum range of several miles between the cellular base station and the handset, even with the additional 30 dB environmental losses described above. Therefore, 30 dB of window shielding attenuation may not be sufficient for disabling communication between terrestrial base stations and aircraft passenger cellular phones when the aircraft is on the ground, especially when the cellular tower is located in close proximity to the aircraft, as they often are at airports. However, once the aircraft reaches cruise altitude there is typically several miles of range to the terrestrial base station such that the 30 dB of window shielding attenuation is sufficient to disable communications with the ground.

The conductive film of the present disclosure introduces approximately 30 dB or more of RF signal attenuation to effectively block the electromagnetic radiation generated by the wireless cellular device at the window of a mobile platform. Conductive films which produce less than or greater than 30 dB attenuation can also be used in a wireless communication system of the present invention. A conductive film of the present disclosure can also be disposed within a laminated window, i.e., a multi-pane window constructed with an intermediate layer of conductive film in contact with adjoining panes of the window. In a further embodiment of the present disclosure, one or more grounding straps (i.e., item 144 shown in FIG. 6) can be used to supplement the clips 106 shown in FIG. 3. Wireless devices compatible with the system of the present disclosure include wireless telephones and other wireless cellular devices; wireless data transmission devices, including laptop computers and electronic notepads; wireless access points; Wi-Fi portable devices; etc.

An additional network security benefit is also provided by the invention because outside intruders using wireless devices are less able to gain access to the wireless infrastructure inside the aircraft fuselage because of the RF isolation provided by the shielded windows.

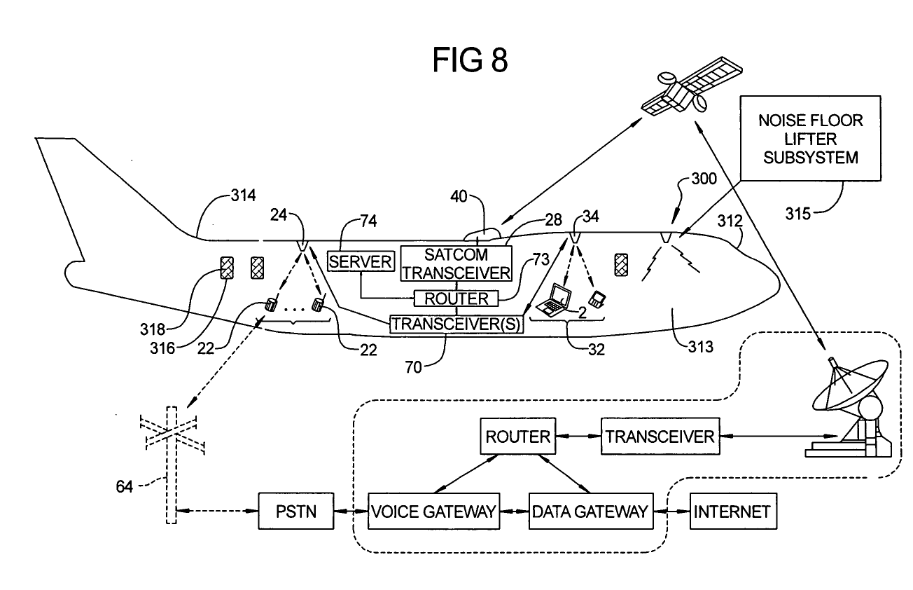

Referring to FIG. 8, an alternative embodiment 300 of the present disclosure is shown. In this embodiment, components in common with the embodiment 10 of FIG. 1 are designated with reference numerals increased by 300 over those used in FIG. 1.

The system 300 does not rely on shielding 318 of the window 316, and the shielding provided by the fuselage 314 to achieve the necessary degree of attenuation of wireless signals being radiated into the interior area of the aircraft 312 from the terrestrial base station 64. Instead, the system 300 employs a noise floor lifter subsystem 315 located within the interior cabin area 313 of the mobile platform 312 to raise the noise “floor” within the interior cabin area 313. Cooperatively, the shielding provided by the fuselage 314 and the noise floor lifter subsystem 315 provide the needed level of signal attenuation of the wireless signal from the terrestrial base station 64 to prevent the cellular devices 22 from making a connection with the terrestrial base station 64.

In one specific form the noise floor lifter subsystem 315 comprises a conventional white noise generator that generates a white noise signal having a constant spectral power density within a predetermined frequency spectrum used by the cellular devices 22. The implementation of the noise floor lifter subsystem 315 enables a lesser degree of shielding to be implemented on the windows 316 of the aircraft 312. In various applications, the system 300 may represent a more cost effective approach to achieving the needed degree of signal strength attenuation of cellular signals transmitted into the cabin area 313 of the aircraft 312. In one specific form, the shielding of the fuselage 314 and the shielding over the windows 316 of the aircraft 312 provides about 50% of the overall signal strength attenuation needed to prevent the cellular devices 22 from receiving and responding to cellular signals from the base station 64. The remaining 50% of the needed signal strength attenuation is provided by the noise floor lifter subsystem 315. Presently, about 40 dB of noise reduction is needed of the cellular signal entering the interior cabin area 313 of the aircraft 312 to prevent communication with the cellular devices 22. Thus, in one form, about 20 dB of signal-to-noise attenuation is provided by the shielding of the aircraft 312 and the remaining 20 dB is provided by the noise floor lifter subsystem 315.

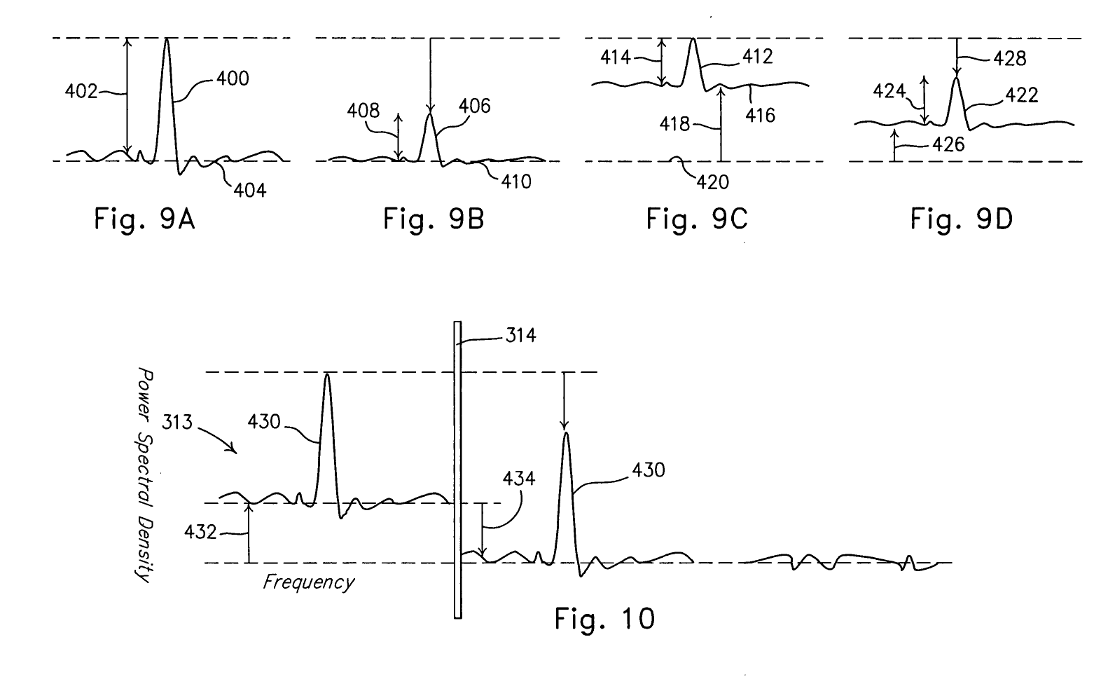

Referring to FIGS. 9A-9D, the affect of the noise floor lifter subsystem 315 on the cellular signals being transmitted into the interior cabin area 313 of the aircraft 312 is illustrated, as well as the affect of the shielding of the aircraft. FIG. 9A illustrates an electromagnetic wave (i.e., cellular) signal 400 that is received within the interior cabin area 313 of the aircraft 312. Arrow 402 indicates the signal-to-noise ratio of the signal 400, and dashed line 404 illustrates the ambient noise level within the aircraft 312. FIG. 9B illustrates the full, needed attenuation on the signal 400 by just the shielding provided by the fuselage 314 of the aircraft 312 and the shielding 318 on the windows 316. Arrow 408 indicates the significantly reduced signal-to-noise ratio, while dashed line 410 indicates the ambient noise level within the interior cabin area 313. In FIG. 9C, waveform 412 illustrates the affect of signal-to-noise ratio attenuation provided by only the noise floor lifter subsystem 315. The signal-to-noise ratio is indicated by arrow 414 and the noise floor, indicated by reference numeral 416, is elevated, as indicated by arrow 418, above the previous ambient noise level, indicated by dashed line 420. Thus, in FIG. 9C, the entire degree of signal-to-noise ratio attenuation needed to prevent cellular devices 22 from operating is provided by the noise floor lifter subsystem 315.

Referring to FIG. 9D, a graph illustrating the implementation of both shielding attenuation from the aircraft 312 and noise floor lifting attenuation is illustrated. Waveform 422 illustrates the signal received within the interior cabin area 313 of the aircraft 312. Arrow 424 indicates the signal-to-noise ratio of the signal 422, and arrow 426 indicates the amount by which the noise floor is lifted by the noise floor lifter subsystem 315. Arrow 428 indicates the shielding attenuation provided by the fuselage 314 and windows 316 of the aircraft 312. From FIG. 9D, it will be appreciated that roughly about 50% of the reduction in the signal-to-noise ratio 424 of the signal 422 comes from the noise floor lifter subsystem, and about 50% from the aircraft 312, fuselage 314 and windows 316.

The present system thus eliminates the drawback of previous systems that use only noise floor liftering to control the use of cellular/PDA devices from within an aircraft; that drawback being that the relatively high amount of noise generated might potentially interfere with sensitive navigation equipment on the aircraft 312.

It will also be appreciated that the shielding of the aircraft 312 can reduce RF radiation levels outside of the fuselage to levels that are below the threshold where they might cause harmful interference, as indicated in FIG. 10. In one specific implementation, the amount of noise floor lifting within the aircraft fuselage 314 can be made equal to the amount of aircraft shielding attenuation such that the radiated noise floor level outside of the fuselage is approximately equal to the ambient thermal noise floor. This is illustrated in FIG. 10. Signal 430 has its signal-to-noise ratio attenuated by the lifted noise floor, indicated by arrow 432, on the inside cabin area 313 of the aircraft 312. The fuselage 314 is represented in simplified diagrammatic form by a narrow vertical rectangle. On the outside of the fuselage 314, the shielding provided by the fuselage 314 attenuates the noise signal generated within the fuselage, as indicated by arrow 434. Thus, the attenuation in the signal-to-noise ratio of the signal 430 outside of the aircraft 312 is approximately equal to that amount by which the noise floor is lifted (i.e., indicated by line 432). On the outside of the fuselage 314, the shielding of the aircraft 312 reduces the noise floor to that of the ambient thermal noise (kT). Thus, the fuselage shielding reduces both the signal strength of signal 430 (from the picocell or cellular device) and the noise level from the noise floor lifter subsystem 315.

An additional benefit of the present system is that the noise floor lifter subsystem 315 can be constructed simply and inexpensively because it can operate at fixed power levels and with a relatively wide bandwidth. In contrast, when only noise floor lifting is employed within the fuselage, significant care must be taken as to which channels (i.e., frequencies) are jammed and what power levels are used to perform jamming because there is a potential for interfering into terrestrial wireless networks remote from the aircraft. For example, one known method involves sensing the frequencies and amplitudes of the signals to be jammed, and then using only sufficient power on those particular frequencies to generate a jamming signal to prevent off-board communications. This method must raise the on-board picocell transmission amplitude by one decibel for every decibel increase in noise floor level within the aircraft. This requires a sophisticated and relatively expensive implementation that may still provide an unacceptably high risk of interference to terrestrial networks.

The present system thus inhibits communication of cellular and/or PDA devices directly with a terrestrial-based wireless access point, but without increasing the risk of interference to such terrestrial-based networks. By employing both the shielding of the mobile platform itself, in connection with noise floor lifting, a level of signal-to-noise reduction attenuation in the wireless signal entering into the interior cabin area of a mobile platform can be achieved that prevents cellular/PDA devices from responding to the signal and thus transmitting. Importantly, the degree of noise floor lifting employed does not give rise to a significant risk of interference with terrestrial wireless networks. The system 300 and method can be implemented in virtually any form of mobile platform (e.g., bus, ship, train, rotorcraft, etc.) where it would be desirable to limit use of cellular devices by passengers during certain phases of operation of the mobile platform.

What is claimed is:

1. A method for attenuating electromagnetic (EM) signals passing through a body of a mobile platform, comprising:
shielding the body of the mobile platform to provide a first degree of reduction in a signal-to-noise ratio of an EM signal radiating into an interior cabin area of said mobile platform from outside of said mobile platform; and
generating a noise signal within an interior cabin area of the mobile platform, and within a predetermined frequency band, to raise an EM noise floor in said interior cabin area of said mobile platform to provide a second degree of reduction in the signal-to-noise ratio of said EM signal radiating into said interior cabin area.

2. The method of claim 1, wherein said first and second degrees of reduction of said signal-to-noise ratio of said EM signals is sufficient to prevent wireless devices in said cabin area from receiving said EM signals.

3. The method of claim 1, wherein said first and second degrees of attenuation of said EM wave signal within interior cabin area comprise a total reduction in said signal-to-noise ratio of between about 20 dB-50 dB.

4. The method of claim 1, wherein generating a noise signal comprises generating a white noise signal over at least one cellular frequency band.

5. The method of claim 1, wherein generating a noise signal comprises generating a constant power spectral density noise signal over a predetermined frequency band.

6. The method of claim 1, wherein generating a noise signal comprises generating a noise signal sufficient to reduce said signal-to-noise ratio of said EM signal entering said interior cabin area by about 10 dB-25 dB.

7. The method of claim 1, wherein shielding the body of the mobile platform to provide a first degree of signal-to-noise reduction comprises reducing a signal-to-noise ratio of said EM signal entering said interior cabin area by about 10 dB to 25 dB.

8. A method for reducing electromagnetic (EM) signals passing through a body of a mobile platform, comprising:
shielding the body of the mobile platform to provide a first degree of reduction of a signal-to-noise ratio of EM signals radiating into an interior cabin area of said mobile platform from outside of said mobile platform; and
generating a white noise signal within an interior cabin area of the mobile platform, and within a frequency band used by a user operated wireless device, to raise an EM noise floor in said interior cabin area of said mobile platform to provide a second degree of reduction in the signal-to-noise ratio of said EM signal radiating into said interior cabin area; said first and second degrees of reduction of said signal-to-noise ratio cooperatively being sufficient to prevent use of said user operated wireless device within said interior cabin area.

9. The method of claim 8, wherein said first shielding degree of attenuation of said signal-to-noise ratio of said EM signal comprises an attenuation of between about 10 dB-25 dB.

10. The method of claim 8, wherein said second degree of attenuation of said signal-to-noise ratio of said EM signal comprises an attenuation of between about 10 dB-25 dB.

11. The method of claim 8, wherein said first and second degrees of reduction of said signal-to-noise ratio of said EM signal comprises a total attenuation of about 10 dB-50 dB.

12. The method of claim 8, wherein generating said white noise signal comprises generating a white noise signal having a constant power spectral density.

13. A system for attenuating electromagnetic (EM) wave signals passing through a body of a mobile platform, comprising:
shielding material covering at least a substantial portion of the body of the mobile platform to provide a first degree of reduction in a signal-to-noise ratio of an EM signal radiating into an interior cabin area of said mobile platform from a wireless access point located outside of said mobile platform; and
a noise signal generator disposed within an interior cabin area of the mobile platform, for generating a noise signal within a frequency band used by a user operated wireless device, to raise an EM noise floor in said interior cabin area of said mobile platform to provide a second degree of reduction in the signal-to-noise ratio of said EM signal radiating into said interior cabin area, said first and second degrees of reduction of said signal-to-noise ratio cooperatively preventing use of said user operated wireless device within said interior cabin area.

14. The system of claim 13, wherein said first degree of reduction of said signal-to-noise ratio of said EM signal comprises an attenuation of between about 10 dB-25 dB.

15. The system of claim 13, wherein said second degree of reduction of said signal-to-noise ratio of said EM signal comprises an reduction of between about 10 dB-25 dB.

16. The system of claim 13, wherein said first and second degrees of attenuation of said signal-to-noise ratio of said EM signal comprises a total attenuation of about 10 dB-50 dB.
